(19) United States
(12) Patent Application Publication
(10) Pub. No.: US 2019/0208456 A1
(43) Pub. Date: Jul. 4, 2019

(54) METHOD AND APPARATUS FOR MOTION DETECTION SYSTEMS

(71) Applicant: QUALCOMM Incorporated, San Diego, CA (US)

(72) Inventors: Mahbod Mofidi, San Diego, CA (US); Arild Kolsrud, El Cajon, CA (US); Paul Butler, San Jose, CA (US); Xiaoxin Zhang, Sunnyvale, CA (US)

(21) Appl. No.: 15/856,820

(22) Filed: Dec. 28, 2017

(51) Int. Cl. H04W 40/02; H04L 5/14; H04W 4/80; H04W 24/08; H04L 12/741; G06F 3/01

(52) U.S. Cl. CPC H04W 40/02; H04L 5/14; H04W 4/80; H04N 21/44218; H04L 45/74; G06F 3/017; H04W 24/08

(57) ABSTRACT

Various aspects for motion detection and/or gesture recognition in a wireless communication device are disclosed, and may include a transmit/receive radio frequency switch including a control input for controlling radio frequency signal routing of the switch from a radio frequency transmit port of the wireless device to an antenna and from the antenna to a radio frequency receive port of the wireless device, a first radio frequency coupler for coupling to the transmit port of the wireless device and for passing of transmit signals from the transmit port to the antenna through the switch, a second radio frequency coupler for coupling to the receive port of the wireless device and for passing of receive signals from the antenna to the receive port through the switch, and a connector for connecting a transmit isolation port of the first coupler to a receive isolation port of the second coupler.

### TECHNICAL FIELD

This disclosure relates generally to method and apparatus for motion detection and/or gesture recognition systems based on wireless signals.

### DESCRIPTION OF THE RELATED TECHNOLOGY

A wireless local area network (WLAN) may be formed by one or more access points (APs) that provide a shared wireless medium for use by a number of client devices. Each AP, which may correspond to a Basic Service Set (BSS), periodically broadcasts beacon frames to enable compatible client devices within a wireless range of the AP to establish and maintain a communication link with the WLAN. WLANs that operate in accordance with the IEEE 802.11 family of standards are commonly referred to as Wi-Fi networks, and client devices that communicate with the AP in a Wi-Fi network may be referred to as wireless stations (STAs).

Bluetooth technology also allows a number of wireless devices to communicate with each other using radio-frequency signals. Although similar in some aspects to Wi-Fi devices, Bluetooth devices typically communicate with each other without the presence of an AP (or other central controller). In addition, although Bluetooth devices typically have shorter wireless ranges than Wi-Fi devices, Bluetooth radios are less expensive and consume less power than Wi-Fi radios. As a result, Bluetooth technology is particularly well suited for applications (such as the Internet of Things) in which minimizing power consumption may be more important than achieving high data rates.

The Internet of Things (IoT) may refer to a communication system in which a wide variety of objects and devices wirelessly communicate with each other. Although many IoT devices such as smart appliances, smart televisions, and smart thermostats support both Wi-Fi and Bluetooth communication protocols, some IoT devices such as TV remote controls, sensors, and other battery powered devices may only support Bluetooth communications, for example, to minimize power consumption.

In relation to various features and capabilities of the IoT devices, there is a strong desire to include the capability for detection of motion and/or gesture recognition in such devices. In one example, one may have the desire to detect motion of an object and/or gesture recognition in a proximity of a television set. The result of the motion detection and/or gesture recognition may be used as a way to interact with the television set, as one example. Among many different functions that could be envisioned are for example: changing the television channel, increasing or decreasing television speakers volume, animating a picture on the television screen, etc.

Considering IoT devices are envisioned to include many different devices having a requirement of low manufacturing cost, adding the capability for detection of motion and/or gesture recognition in such devices should be through a low cost solution and with minimal reconfiguration or minimal change of the existing design of such IoT devices.

### SUMMARY

Various aspects of the disclosure for motion detection and/or gesture recognition in a wireless communication device may include a transmit/receive radio frequency switch including a control input for controlling radio frequency signal routing of the switch from a radio frequency transmit port of the wireless device to an antenna and from the antenna to a radio frequency receive port of the wireless device, a first radio frequency coupler for coupling to the radio frequency transmit port of the wireless device and for passing of transmit signals from the radio frequency transmit port to the antenna through the switch, a second radio frequency coupler for coupling to the radio frequency receive port of the wireless device and for passing of receive signals from the antenna to the radio frequency receive port through the switch, and a connector for connecting a transmit isolation port of the first coupler to a receive isolation port of the second coupler. One or more connectors may be connecting a transmit coupled port of the first coupler and a receive coupled port of the second coupler to ground. A processor coupled with computer readable memory for storing instructions that when executed by the processor cause the processor to perform operations including: determining whether a source address of a received data packet is a source address of the wireless device, determining whether a process for the motion detection and/or gesture recognition is enabled in the wireless device, and processing one or more received signals for the motion detection and gesture recognition occurring in a proximity of the wireless device if the source address of the received data packet is the source address of the wireless device and the process for the motion detection and gesture recognition is enabled in the wireless device. The received data packet is carried by at least one of the one or more received signals that are transmitted from the transmit port of the wireless device and received at the receive port of the wireless device while maintaining signal routing of the switch to route transmit signals from the radio frequency transmit port of the wireless device to the antenna. The operation may include enabling the process for the motion detection and/or gesture recognition based on whether a channel condition experienced by the wireless device exhibiting an amount of signal interference below a signal interference threshold. The received data packet may be a Bluetooth data packet carrying the source address. The processing of one or more received signals for the motion detection and/or gesture recognition may include correlating at least one characteristic pattern of the one or more received signals to one or more different characteristic patterns associated with different motion and/or gesture recognition characteristic patterns. The operation may include performing one or more specific task based at least on a result of the correlating at least one characteristic pattern of the one or more received signals to one or more different characteristic patterns. The operation may include indicating presence of motion and/or recognizing a gesture of an object or body in the proximity of the wireless device when the correlating at least one characteristic pattern of the one or more received signals to one or more different characteristic patterns satisfies a correlation threshold. The one or more received signals may be transmitted based on a Time Division Duplex (TDD) transmission scheme. A receive operation of the wireless device may be in an active receiving state during a transmit timing portion of the TDD transmission scheme. The one or more received signals are transmitted from the transmit port of the wireless device and received at the receive port of the wireless device. The one or more received signals may be transmitted in an active communication with another device. The operation may include determining a channel condition experienced by the wireless device and adjusting a correlation threshold level based on the determined channel condition for correlating at least one characteristic pattern of the one or more received signals to one or more different characteristic patterns.

### BRIEF DESCRIPTION OF THE DRAWINGS

FIG. 1 shows an example wireless network where a wireless device is connected to at least one other wireless device through one or more wireless communication signal.

FIG. 2 shows a block diagram of an example wireless device.

FIG. 3 shows a frame format of a data packet related to Bluetooth protocols that may be transmitted via a wireless signal to another device.

FIG. 4 shows an exemplary block diagram of a transceiver system with two antennas for motion detection and/or gesture recognition.

FIG. 5 shows an exemplary block diagram of a transceiver system with one antenna, a transmit/receive switch, and two couplers for motion detection and/or gesture recognition.

FIG. 6 depicts exemplary amplitude variation of the reflected signal produced by movement and/or gesture of a human hand at various distances.

FIG. 7 depicts exemplary amplitude variation of the reflected signal produced by various movement and/or gesture of a human hand.

FIG. 8 depicts exemplary amplitude variation of the reflected signal produced by movement and/or gesture of a human hand between two points.

FIG. 9 depicts an exemplary block diagram of a transceiver system with one antenna, a transmit/receive switch, and two couplers for motion detection and/or gesture recognition.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving RF signals. The transmission and reception of the RF signals may be according to a particular communication Standard, such as any of the IEEE 802.11 standards, and the Bluetooth® specification. Moreover, the device may also be operating in accordance with any of the cellular communication protocols such as (but not limited to) code division multiple access (CDMA), frequency division multiple access (FDMA), time division multiple access (TDMA), Global System for Mobile communications (GSM), GSM/General Packet Radio Service (GPRS), and Enhanced Data GSM Environment (EDGE), or other known communication signals that are used to communicate within a wireless, cellular or internet of things (TOT) network, such as a system utilizing 3G, 4G or 5G, or further implementations thereof, technology.

Given the increasing number of IoT devices deployed in home and business networks, it is desirable to have a feature of motion detection and/or gesture recognition in the area served by such devices. In one example, when a person enters or leaves a particular area or room, based on the detection of motion and/or gesture recognition in the area, such IoT devices can be turned on or off. More specifically, many home networks may include smart devices and appliances such as smart TVs and entertainment systems, smart garage doors, smart lighting systems, smart sound systems, smart security systems, and smart temperature control systems that may benefit from the information indicating movement of a person or object and/or gesture recognition within and around such home networks. However, because dedicated motion sensors can increase costs and complexity of such IoT devices, it would be desirable to detect motion and/or gesture recognition without adding or using dedicated motion sensors.

In some implementations, the IoT device may perform one or more operations based on at least one of the detected motion and the gesture recognition. In some aspects, a software program executing instructions in the IoT device may send commands to one or more firmware or hardware components to trigger one or more operations in response to at least one of the detected motion and the gesture recognition. In addition, or in alternative, the IoT device may send commands to other devices for performing one or more operations.

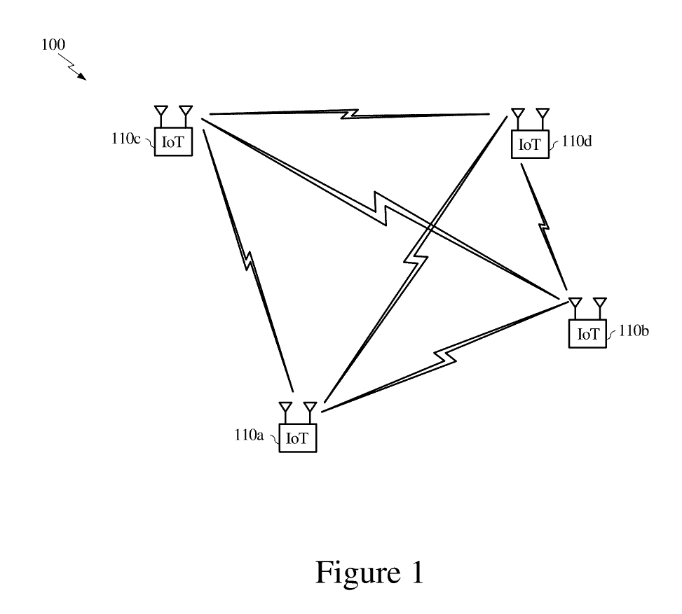

FIG. 1 shows a block diagram of an example wireless system 100. The wireless system 100 is shown to include a plurality of Internet of Things (IoT) devices 110a-110d. In some implementations, the IoT devices 110a-110d may form a personal area network (PAN) and communicate with each other according to one or more Bluetooth protocols including, for example, Basic Rate Bluetooth, Enhanced Bluetooth, and Bluetooth Low Energy (BLE). In some aspects, the IoT devices 110a-110d may form a mesh network. In other implementations, the IoT devices 110a-110d also may be capable of communicating with each other using Wi-Fi communications, such as defined by the IEEE 802.11 family of standards. Thus, in at least some implementations, the IoT devices 110a-110d may communicate with each other using transmission and reception of wireless signals based on one or more wireless communication protocols, for example Wi-Fi and Bluetooth. In other implementations, the IoT devices 110a-110d may communicate with each other using only (or at least primarily) Bluetooth communication protocols.

Each of the IoT devices 110a-110d may be any suitable device capable of operating according to one or more communication protocols associated with IoT systems. For example, each of the IoT devices 110a-110d can be a smart television (TV), a remote control for the smart TV, a smart appliance, a smart meter, a smart thermostat or other temperature control system, a smart sensor, a gaming console, a set-top box, a smart light switch, a component of a smart sound system (such as a speaker), a smart garage opener, and the like. In some implementations, each of IoT devices 110a-110d may include a transceiver, one or more processing resources (such as processors or ASICs), one or more memory resources, and a power source (such as a battery). The memory resources may include a non-transitory computer-readable medium (such as one or more nonvolatile memory elements, such as EPROM, EEPROM, Flash memory, a hard drive, etc.) that stores instructions for performing operations described throughout.

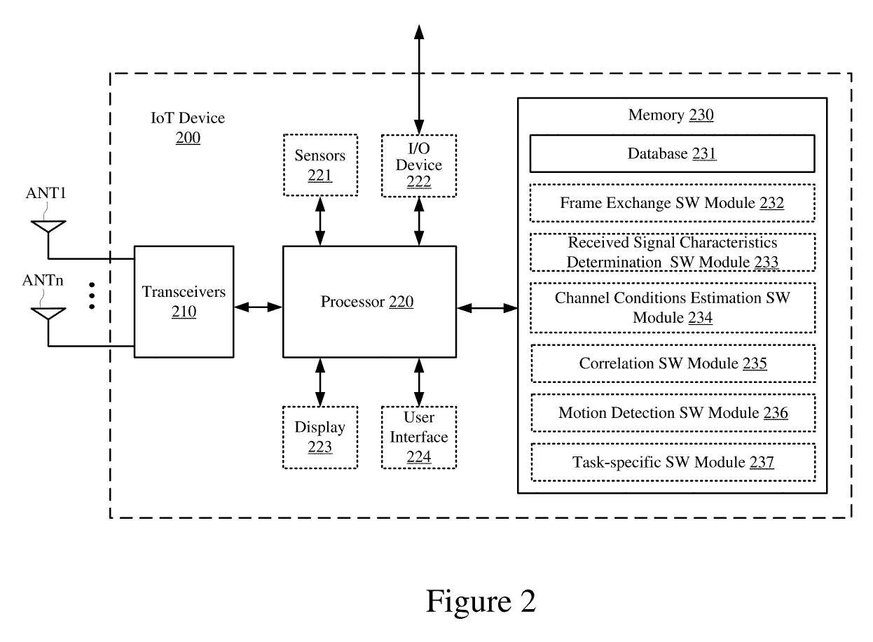

FIG. 2 shows an example IoT device 200. The IoT device 200 may be one implementation of the IoT devices 110a-110d of FIG. 1. Considering that an IoT device may be a number of different devices, such as: television, smart meter, remote control, etc., the block diagram shown in FIG. 2 may not include one or more blocks associated with the functions of such IoT devices. The IoT device 200 includes one or more transceivers 210, a processor 220, a memory 230, and one or more antennas ANT1-ANTn. The transceivers 210 may be coupled to the antennas ANT1-ANTn, either directly or through an antenna selection circuit (not shown for simplicity). The transceivers 210 may be used to transmit and receive wireless signals from other IoT devices, or any other suitable wireless device. Although not shown in FIG. 2 for simplicity, the transceivers 210 may include any number of transmit chains to process and transmit signals to other wireless devices via antennas ANT1-ANTn, and may include any number of receive chains to process wireless signals received from antennas ANT1-ANTn. For purposes of discussion herein, the processor 220 is shown as coupled between the transceivers 210 and the memory 230. For actual implementations, the transceivers 210, the processor 220, and the memory 230 may be connected together using one or more buses (not shown for simplicity). Moreover, the antennas ANT1-ANTn may be integrated with various components of transceiver 210. For example, the antennas ANT1-ANTn may be metallically printed on a circuit board and/or on semiconductor material of transceiver 210 integrated circuits.

The IoT device 200 may optionally include one or more of sensors 221, an input/output (I/O) device 222, a display 223, a user interface 224, and any other suitable component. For one example in which IoT device 200 is a smart television, the display 223 may be a TV screen, the I/O device 224 may provide audio-visual inputs and outputs, the user interface 224 may be a control panel, a remote control, and so on. For another example in which the IoT device 200 is a smart appliance, the display 223 may provide status information, and the user interface 224 may be a control panel to control operation of the smart appliance.

The memory 230 may include a database 231 that stores profile information for a plurality of wireless devices such as Bluetooth devices, APs, stations, and other IoT devices. The profile information for a particular device may include, for example, the SSID, MAC address, the device's IP address, channel information, RSSI values, throughput values, channel state information (CSI), supported data rates, connection history, a trustworthiness value indicating a level of confidence about the device service location, and any other suitable information pertaining to or describing the operation of the device. The profile information may also include, for example, preferred frequency bands or channels, frequency hopping schedules, a number of capabilities, and any other suitable information pertaining to or describing the operation of the device.

The memory 230 also may include a non-transitory computer-readable storage medium (such as one or more nonvolatile memory elements, such as EPROM, EEPROM, Flash memory, a hard drive, and so on) that may store the following software (SW) modules:
a frame exchange software module 232 to create and exchange messages and packets (such as advertising messages, device discovery messages, service discovery messages, and data packets) between the IoT device 200 and other wireless devices;
a received signal characteristics determination software module 233 to determine various characteristics of the received signal such as: phase and/or amplitude variations, frequency of such variations of the received signals for at least the purpose of motion detection and/or gesture recognition;
a channel conditions software module 234 to estimate channel conditions based on one or more received signals; in at least one aspect, when the channel condition is determined to be free or nearly free or with low level of interference, the condition may be most suitable for carrying out a process for motion detection and/or gesture recognition as described throughout;
a correlation software module 235 for correlating certain characteristics changes of the received signals (i.e. the output of received signal characteristics determination software module 233) to a number of different characteristics variation patterns for at least the purpose of motion detection and/or gesture recognition;
a motion detection and gesture recognition software module 236 for detecting or determining a presence of motion and/or recognizing gesture based at least in part on the output of the received signal characteristics determination software module 233 and/or the correlation software module 235; and
a task-specific software module 237 to facilitate the performance of one or more tasks based at least on the output of the motion detection and gesture recognition software module 236.
   Each software module includes instructions that, when executed by the processor 220, may cause the IoT device 200 to perform the corresponding functions. The software modules depicted and explained throughout may be parts of one software module, but for the purpose of clarity and explanation, such modules are shown and described to be different modules. The functions of such software modules may be combined into one or more different modules than what has been depicted and explained throughout. The non-transitory computer-readable medium of the memory 230 thus includes instructions for performing all or a portion of the operations described throughout.

The processor 220 may be any one or more suitable processors capable of executing scripts or instructions of one or more software programs stored in the IoT device 200 (such as within the memory 230). Although memory 230 is shown desperately, one or more segments of memory 230 may be a part of processor 220. Processor 220 may execute the frame exchange software module 232 to create and exchange messages and packets (such as advertising messages, device discovery messages, service discovery messages, and data packets) between the IoT device 200 and other wireless devices.

The processor 220 may execute the channel conditions estimation software module 234 to estimate channel conditions based on one or more packets received from other wireless devices. In some implementations, the channel conditions estimation software module 234 may be executed based on sequences contained in received Bluetooth packets. The channel conditions estimation software module 234 may also determine whether motion detection and/or gesture recognition processes could be carried out. For example, when the interference level as determined by the channel conditions estimation software module 234 is at or below a particular level, the process for motion detection and/or gesture recognition may be carried out. The interference may be caused by a number of devices in the same or nearby area transmitting wireless signals that are received at IoT device 200. Therefore, the channel conditions estimation software module 234 may enable or disable, depending on the interference level, the processes for motion detection and/or gesture recognition.

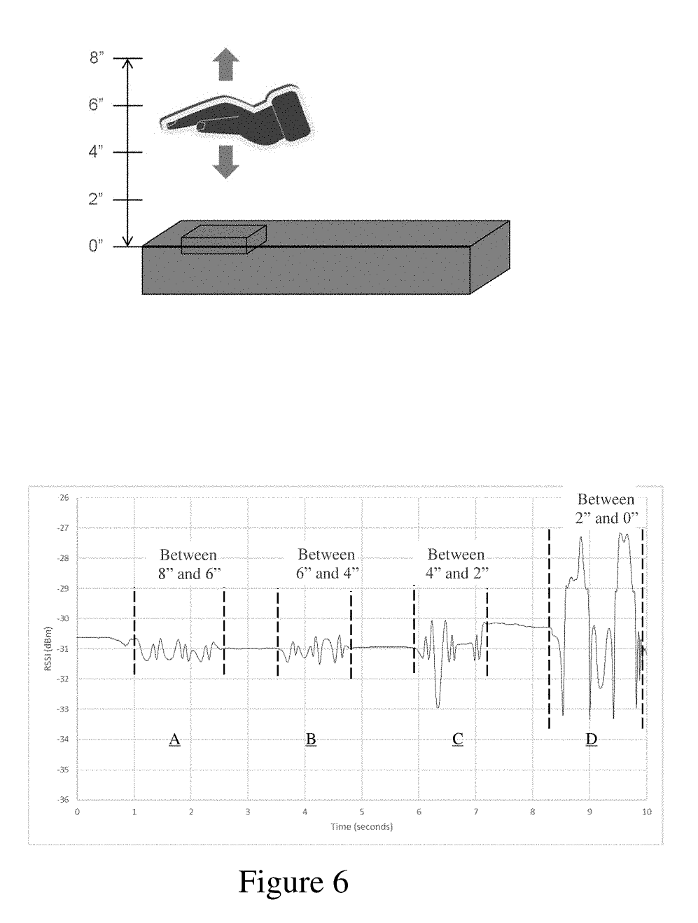

The processor 220 may execute the correlation software module 235 to determine, over a period of time or a plurality of different times, whether certain correlation exists in a wireless received signal for the purpose of further processing of the signal. Moreover, the correlation software module 235 may determine whether the characteristics changes or differences in the received wireless signals are at least correlating to any number of different characteristics variation patterns. For example, memory 230 may store certain wireless signal characteristics variations (e.g. the phase and/or amplitude variations patterns and/or frequency of such variations) that are representing the effect of different possible motion of an object and/or gesture in a proximity of the IoT device 200. Several of such wireless signal characteristics variations patterns associated with different movement and gestures are depicted and explained in relation to FIGS. 6, 7 and 8. The wireless signal characteristics variations patterns depicted and explained in relation to FIGS. 6, 7 and 8 are shown in a form of amplitude variation. However, the depicted signal variation patterns may be further processed through a Fast Fourier Transform processes to determine the frequency components for determining the frequency content of such variations. The phase component of such signals may also be determined through a process of determining the In-phase and Quadrature-Phase of such signals. Other characteristics of such patterns may also be determined. Such patterns and their associated characteristics may be stored in IoT device 200 (e.g. memory 230). Furthermore, incorporated by reference herein, a technical publication titled: Quadrature Demodulation with DC Cancellation for a Doppler Radar Motion Detector, by Byung-Kwon Part, et al, published in 2007 by IEEE outlines various aspects of processing I and Q received signals for motion detection and/or gesture recognition. Complex constellation of quadrature of receiver outputs due to periodic motion and/or gesture are analyzed for determining whether a moving object/body is in a proximity of a wireless device.

The processor 220 may execute the motion detection and gesture recognition software module 236 to detect or determine motion of an object/person and/or recognize gesture based on the changes or differences determined by at least the received signal characteristics determination software module 233 and/or the correlation software module 235. In some implementations, the motion detection software module 236 may be executed to detect motion and/or recognize gesture based on the differences of the received signal at different times.

The processor 220 may execute the task-specific software module 237 to facilitate the performance of one or more tasks that may be specific to the IoT device 200. For one example in which the IoT device 200 is a smart TV, execution of the task specific software module 237 may cause the smart TV to turn on and off, to select an input source, to select an output device, to stream video, to select a channel, and so on (or to control one or more operations of an associated remote control). For another example in which the IoT device 200 is a remote control for the smart TV, execution of the task specific software module 237 may cause the remote control to control one or more operations of the smart TV, to control one or more operations of the remote control, or both.

In some aspects, when the IoT device 200 detects motion of an object/person and/or recognizes certain hand or body gestures, the IoT device 200 may transmit a message that may control the operation of other devices. For one example, if the IoT device 200 determines that a person is walking towards the smart TV, the IoT device 200 may cause the smart TV to turn on. For another example, if the IoT device 200 determines that a person is walking away from the smart TV, the IoT device 200 may cause the smart TV to turn off. Conversely, when the IoT device 200 detects an absence of motion and/or gesture recognition for a period of time, the IoT device 200 may transmit a message that turns off the smart TV. In this example, detecting absence of any movement in a proximity of the television set may cause the task specific software module 237 to be executed to turn off the television set after a period of time.

In some aspects, execution of the task specific software module 237 also may be used to exchange capabilities with another wireless device and to negotiate a number of parameters for motion detection and/or gesture recognition operations. The number of negotiated parameters may include, for example, a channel to be used for transmitting packets and supplemental information, a frequency-hopping schedule to be used for transmitting packets and supplemental information, and one or more characteristics of the supplemental information to be appended to packets.

Implementations of the subject matter described throughout can be used to detect motion and/or recognize gesture using wireless signals transmitted and received by the IoT devices of such wireless networks without using dedicated motion sensors. Generally, in network 100, a receiving device may receive, from a transmitting device, a packet that contains or is associated with a source identifying sequence (i.e. identification sequence) that is known to the receiving device. In some aspects, the packet may be a Bluetooth packet (such as a Bluetooth Low Energy (BLE) packet) including a supplemental information that contains the known sequence. In other aspects, the packet may be transmitted using another suitable wireless communications protocol (such as a Wi-Fi packet compatible with the IEEE 802.11 standards), and the source identifying sequence may be included within or appended to the packet in any suitable manner.

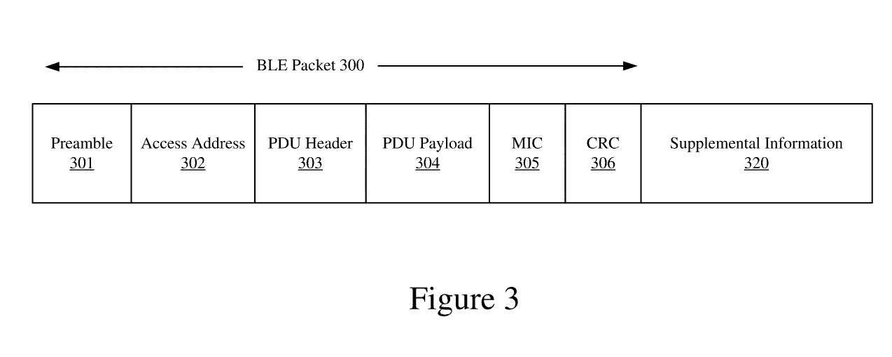

FIG. 3 shows an example BLE packet 300. The BLE packet 300 includes a preamble 301, an access address 302, a protocol data unit (PDU) header 303, a PDU payload 304, a Message Integrity Check (MIC) 305, and a cyclic redundancy check (CRC) 306. In some implementations, the entire BLE packet 300 is transmitted at the same symbol rate, for example, using either 1 Ms/s or 2 Ms/s modulation. The preamble 301 may contain timing and synchronization information. The access address 302 may contain an identification sequence. The identification sequence may include a source address and a destination address. The source address is normally the address of the device transmitting the packet, and the destination address is the address of the intended recipient device. Various aspects of the present disclosure may leverage the access address 302 information for the purpose of motion detection and/or gesture recognition. The PDU header 303 may contain one or more identifiers. In some implementations, for data channel PDUs, the PDU header 303 contains the Logical Link Identifier (LLID), the Next Expected Sequence Number (NESN), Sequence Number (SN), More Data (MD), the payload length and an indication of whether there is supplemental information 320 present. The MIC 305 value may be used to authenticate the integrity of the data carried by the BLE packet 300. The CRC 306 may be used for error correction. The supplemental information 320, which is an optional field that may be appended to the BLE packet 300, may have a duration of between 16 μs and 160 μs. In some aspects, the sequence contained in the supplemental information 320 may be a constantly modulated series of unwhitened logic 1's (such that the sequence is not white noise). Various aspects of the present disclosure, as explained throughout, may leverage the data included in each field of BLE packet 300 including the data in access address 302 and/or the supplemental information 320 for the purpose of motion detection and/or gesture recognition.

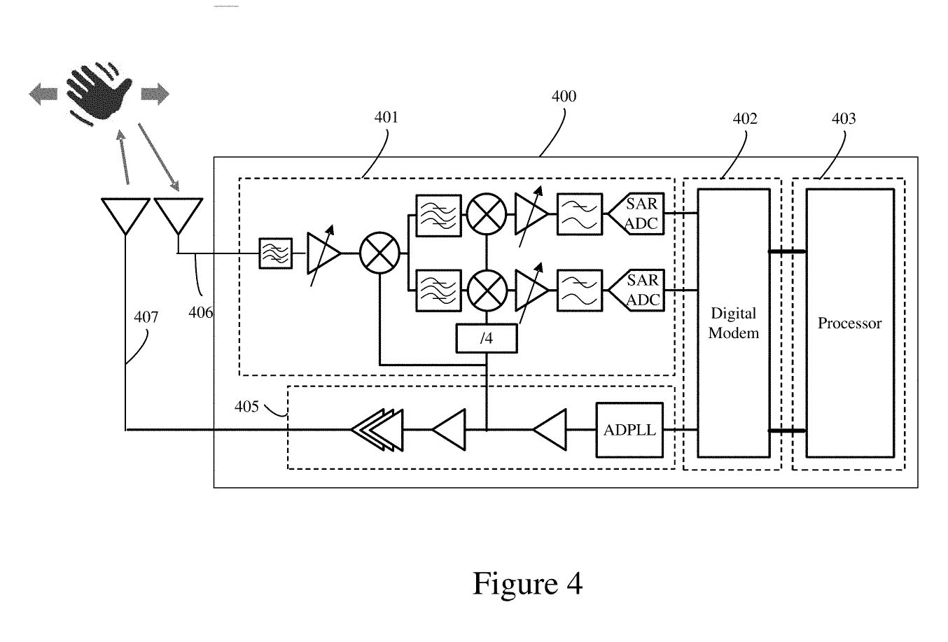

Referring to FIG. 4, transceiver and processor system 400 is shown. While making an exemplary comparison to the block diagram of IoT device 200 shown in FIG. 2, system 400 may include some or all of the functionalities depicted and described in relation to the operations of transceiver 210 and processor 220. Certain operations of system 400 are explained in relation to Bluetooth packet format. For example, BLE packet 300 includes access address 302 field which includes a specific address of the source (i.e. transmitting) device and a specific address of the destination (i.e. receiving) device. Considering that various aspects of the motion detection and/or gesture recognition depends on identifying the specific address of the source device, the operations may also be explained in relation to other types of communication standards, such as 802.11 Standards, where the access address of the source device or an identification of the source device is normally included in the protocols of the packet transmissions.

System 400 may be coupled with a number of receive antennas and a number of transmit antennas, although one receive antenna 406 and one transmit antenna 407 are shown. For a packet exchange with a destination device, a data packet such as BLE packet 300 may be transmitted from a source device. Considering a number of devices may be receiving the transmitted BLE packet 300, the receiving devices examine the content of access address 302 field, and if the destination address does not match with the address of the receiving device, the receiving device ignores the reception of BLE packet 300. If the destination address is matched with the address of the receiving device, the BLE packet 300 may further be processed by various blocks in system 400. Moreover, the packet exchanges may continue over a number of transmissions from the source device to a destination device. During such packet transmissions, considering the receive antenna 406 and transmit antenna 407 are in a close proximity of each other, receive antenna 406 may also receive (i.e. pick up a reflections) the signal carrying the BLE packet 300 transmitted from transmit antenna 407. Generally, when a signal is transmitted in a space, the transmitted signal is scattered by being reflected from the objects/person in a proximity of the transmitting device. The receive antenna 406 may receive a reflection of the transmitted signal. Normally, an IoT device including the system 400 should ignore the received BLE packet 300 because the source address of the access address field 302 belongs to the same device that has received the BLE packet 300. In accordance with one or more aspects of the disclosure provided throughout, when the source address of the access address field 302 belongs to the same device that has received the BLE packet 300, system 400 would not ignore reception of the BLE packet 300 while the process for a motion detection and/or gesture recognition has been enabled in IoT device 200. For example, IoT device 200 may turn on its feature for motion and/or gesture recognition. The feature may be turned on, for example, by one or more software modules in memory 230. In one example, channel condition estimation SW module 234 may enable or disable the motion detection and/or gesture recognition feature of the IoT device 200 based on the channel condition, preferably the process is enabled when the channel condition exhibits low level of signal interference. After enabling the feature for motion and/or gesture recognition, the IoT device 200 receiving a signal that includes the BLE packet 300 with a source address as the address of the receiving IoT device 200, the IoT device 200 would use the received signal (i.e. reflection of the transmitted signal) for motion detection and/or gesture recognition. In another word, when the IoT device 200 detects receiving its own transmitted signal, the process for motion and/or gesture recognition may take place based on the received signal. As such, in accordance with various aspects of the disclosure, the received signal that has carried BLE packet 300 with the same source address as the address of the receiving device may be used for a motion detection and/or gesture recognition. Moreover, the packet exchanges between a source device and a destination device may be carried out over a number of different transmissions and receptions. Therefore, the process for a motion detection and/or gesture recognition may continue based on such further signals after identifying that the source address of the transmitting device is the same as the address of the receiving device.

System 400 include a receive system 401, a transmit system 405, a digital modem processing 402 and a processor 403. The receive system 401 may include a number of components such: low noise amplifier, mixer, baseband filter and analog to digital converters. The operations of such components are well known. The components and their interconnections are depicted by the generally accepted symbol representations. The transmit system, 405 may include phase lock loop system, filters, and amplifiers. The digital modem processing 402 and processor 403 independently and/or in combination process the received data to determine the content of the received data packets and determine the content the data packets prepared for transmission. The process for a motion detection and/or gesture recognition may be activated by the processor 403 so that when a BLE packet 300 is received identifying the source address of the transmitting device to be the same as the address of the receiving device, system 400 would not ignore the received packet. The processor 403 may activate the process for motion detection and/or gesture recognition based on an input from channel condition estimation software module 234. For example, when the channel condition exhibits presence of a low level of interference, channel condition estimation software module 234 enables the possibility of carrying the process for motion detection and/or gesture recognition, and the processor 403 activates the process when the BLE packet 300 is being received.

Furthermore, the IoT device incorporating system 400 with enabled functionality for a motion detection and/or gesture recognition may be in a normal communication with other IoT devices. By identifying the source address of all the received signals, only the signal received at receive antenna 406 which has been transmitted from antenna 407 is used for a motion detection and/or gesture recognition. Considering the operation of the communication may be based on Time Division Duplex (TDD), the receive operation of the IoT device is normally expected to be in an idle state during the transmit portion of the TDD (i.e. when the IoT device is transmitting a signal). However, when the functionality for a motion detection and/or gesture recognition is enabled, the receive operation is not completely in an idle state in accordance with various aspects of the disclosure. The receive operation in accordance with an aspect of the disclosure is in an active receiving state. As such, during the transmit timing portion of the TDD, the signal transmitted from antenna 407 and received at the receive antenna 406 is not ignored, and further processed for a motion detection and/or gesture recognition. In the event the receive antenna 406 is also receiving signals from other devices while receiving signals from transmit antenna 407, system 400 is able to distinguish such other signals and separate the received signals in the digital modem 402 and/or in connection with certain operations in processor 403. One or more software modules in memory 230 may also be involved in separating the received signals. Such software modules may include received signal characteristics determination software module 233, channel condition estimation software module 234, and correlation software module 235. One or more of such software modules in memory 230 of the IoT device may also be executed/utilized for separating the received signals such that a motion detection and/or gesture recognition is performed based on the signal received at antennas 406 that has been transmitted from antenna 407.

Furthermore, while IoT device 200 is not in a particular communication with other devices, the process for a motion detection and/or gesture recognition may be initiated by the IoT device by specifically transmitting the BLE packet 300 one time or repeatedly from antenna 407 while including its own source address. After detecting the source address being the same address of the receiving device, the processor 403 would activate certain functions associated with system 400 so the reception of the BLE packet 300 by the receive antenna 406 is not ignored. As such, based on the received signals that has been transmitted not necessarily for the purpose of communication with other devices, the process for motion detection and/or gesture recognition may be carried out. Therefore, in accordance with various aspects of the disclosure, the process for motion detection and/or gesture recognition may be carried out at any time based on the signal received at antennas 406 that has been transmitted from antenna 407.

By analyzing the signal received at antennas 406 that has been transmitted from antenna 407, certain motion detection and/or gesture recognition that may be taking place within a proximity of the IoT device may be identified. The motion detection and/or gesture recognition is made possible by signal characteristics determination software module 233 to determine various characteristics changes of the received signal for at least the purpose of motion detection and/or gesture recognition. Such characteristics variation may include phase and/or amplitude variations, and/or frequency of such variations of the received signals. The pattern of changes, for example in the phase and/or amplitude of the signal and/or frequency of such variations of the received signals, provide the basis for identifying whether certain motion of an object/person has taken place and/or whether certain gestures, such as a repetitive hand movement or body movement has taken place at a distance from the IoT device, and particularly, at a distance from the antennas 407 and 406. The signal characteristics determination software module 233 is executed for determining such variations of the signal received at antennas 406 that has been transmitted from antenna 407. Different patterns of variations, for example in phase and/or amplitude and/or frequency of changes in phase and/or amplitude changes, in the receive signal at antennas 406 that has been transmitted from antenna 407 may be correlated with different motions and gestures within certain proximity of the IoT device. The correlation software module 235 may be executed for determining whether the pattern of changes matches closely with one or more stored patterns. The amount of correlation may be compared to a correlation threshold. A particular pattern of changes in such signal characteristics or a collection of such patterns may be associated with or correspond to certain motions and/or gestures. Therefore, when a particular pattern, or a collection of patterns, has been correlated (i.e. satisfies a correlation threshold) in processing of the received signal, the motion detection software module 236 may output an indication that a corresponding motion and/or gesture has taken place within a proximity of the IoT device 200. Moreover, for indicating presence of motion and/or recognizing a gesture of an object or body in the proximity of the wireless device, correlating at least one characteristic pattern of the one or more received signals to one or more different characteristic patterns may need to satisfy a specific correlation threshold as described throughout. For example, to minimize false motion detection and/or gesture recognition, the level of the correlation threshold may be set higher at certain times. The level of correlation threshold may change dynamically, and may be dependent on a number of factors, such as the amount of interference that is detected in the channel condition. In one example, at certain hours of the day/night when interference level is relatively low and there is less likely to have many objects/bodies moving in the proximity of the IoT device, the correlation threshold may be set at a low level.

The accuracy of detecting different motions and gestures is improved when the receiver 401 is utilized for determining the pattern of the signal characteristics changes in the received signal. Considering full functionality of the receiver 401 may be used during the transmit portion of the TDD timing, most, if not all, of the unwanted signals may be filtered resulting in processing a signal that is free or nearly free of unwanted interference for determining the pattern of the signal characteristics changes of the receive signal at antennas 406 that has been transmitted from antenna 407.

Considering the operation of the motion detection and/or gesture recognition is made possible by analyzing the signal characteristics changes of the received signal at antennas 406 that has been transmitted from antenna 407, the signal may be any signal including a continuous wave (CW) signal. Since a CW signal does not have a source address and normally is not expected to be transmitted in the vicinity of the IoT device by other sources, when the IoT device is enabled for a motion detection and/or gesture recognition, the process may be performed based on the signal characteristics changes of the received CW signal at antennas 406 that has been transmitted from antenna 407. In the case of using a CW signal, various functioning blocks in system 400 may be turned off or not used. For example, in case of using a CW signal, a low noise amplifier and a signal peak detector may be used for detection of the phase and/or amplitude changes and/or frequency of phase and/or amplitude changes of the received CW signal at antennas 406 that has been transmitted from antenna 407. The pattern of the received signal characteristics changes may be used for determining different motions and gestures within certain proximity of the IoT device.

Considering the operation of the motion detection and/or gesture recognition is made possible by analyzing the received signal characteristics changes at receive antennas 406 that has been transmitted from transmit antenna 407, the isolation between the antennas may be a factor in accuracy of the motion detection and/or gesture recognition. The isolation is referred to the amount of limiting the transmit signal from the transmit antenna 407 to be picked up directly by the receive antenna 406 without being a reflection from the object or human body in close proximity to the IoT device. The accuracy of the motion and/or gesture recognition is improved when the signal characteristics variations of the received signal are more due to signal reflection(s) from the object/human body. Throughout the disclosure as referenced “a received signal” for the motion detection and/or gesture recognition, the received signal of interest is mainly the reflected signal that has been received at the receiving antenna 406 and which has been transmitted from transmit antenna 407. As a signal is transmitted from transmit antennas 407, the signal is propagated in the space and reflected from the objects/bodies within that space. Referring to FIG. 4, as an example, the signal transmitted from antenna 407 may be picked up directly by receive antenna 406 while reflection(s) of the same transmitted signal is also being received. Considering motion detection and/or gesture recognition depends on analyzing the reflected signal, it is best to avoid as much as possible receiving a signal at receive antenna 406 directly from transmit antenna 407. A greater isolation between the receive antenna 406 and transmit antenna 407 provides a more accurate motion detection and/or gesture recognition because the received signal is then more attributed to such signal reflections from objects/bodies in a proximity of the IoT device 200. Moreover, to increase the isolation between the receive antenna 406 and transmit antenna 407, the antennas may physically be placed far apart from each other. In one example, the receive antenna 406 may be located on one side of a television set, and the transmit antenna 407 at another side. Moreover, the transmit antennas 405 and receive antenna 406 may be placed in an orthogonal orientation to each other such that the isolation between the receive antenna 406 and the transmit antenna 405 is increased.

In case of the embodiment(s) as depicted and explained in relation to FIG. 4, for the purpose of motion detection and/or gesture recognition, the transmitter 405 and the transmit antenna 407 may be parts of an entirely different transceiver system than the system incorporating the receive antenna 406 and receive system 401. For example, it is very common to have an IoT device with two separate transceiver systems such as: Bluetooth transceiver system and Wi-Fi transceiver system. In such a case, the transmitter system of the Wi-Fi transceiver system may be used to transmit the signals (e.g. CW signals or any other signals with a source identifier included), and to receive the reflected signal at the receiver of the Bluetooth transceiver system for the purpose of motion detection and/or gesture recognition. Alternatively, the transmitter system of the Bluetooth transceiver system may be used to transmit the signals (e.g. CW signals or any other signals with a source identifier included), and to receive the reflected signal at the receiver of the Wi-Fi transceiver system. The processing of the received signals for the purpose of motion detection and/or gesture recognition could be carried out based on the received signals as explained throughout.

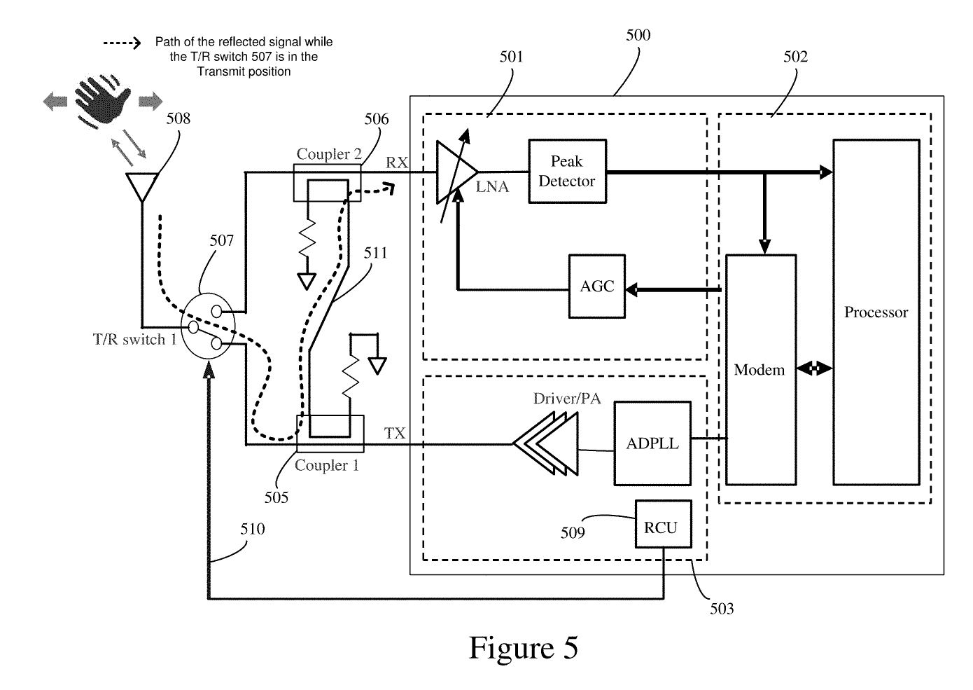

In one or more implementation for the operation of the motion detection and/or gesture recognition, the number of antennas on the IoT device may be limited to only one antenna. Referring to FIG. 5, for the purpose of the operation of the motion detection and/or gesture recognition, a system 500 is depicted and explained throughout with connection to only one antenna. System 500 may include a number of functional blocks, although not all have been shown. For example, filters, oscillators, mixers, etc. that are shown in relation to system 400 may also be present in system 500, but for simplicity, such blocks are not shown in system 500. The system 500 includes a receive system 501 which may include a low noise amplifier, a peak detector, and an automatic gain control system. The receive system 501 is in connection with a signal processing system 502 which may include a modem and a processor. The processing system 502 is in connection with a transmit system 503 which may include a phase lock loop system, power amplifier and a radio control unit (RCU) 509. An antenna 508 is connected to the receive system 501 and transmit system 503 through a combination of Transmit/Receive (T/R) switch 507, and couplers 505 and 506, as depicted, and in accordance with various aspects of the disclosure. The RCU 509 outputs a control signal 510 which controls the signal routing position of the T/R switch 507. When a signal being transmitted, RCU 509 selects a transmit switch position (as shown in FIG. 5) to rout the transmit signal to the antenna 508. When a signal is being received, the RCU 509 selects a receive switch position (not shown in FIG. 5) to route the receive signal to receive system 501.

The process for motion detection and/or gesture recognition may begin by transmitting a signal from transmit system 503 through antenna 508 while passing the transmit signal through coupler 505 and T/R switch 507. The transmit signal from antenna 508 is propagated in the space and also reflected back based on the movement of an object/person in a distance from antenna 508. The reflected signal has certain characteristics variations (as explained throughout) that are considered and correlated with certain movement(s) of the object/person in a proximity of the device. The reflected signal is received through the same T/R switch 507 while is in a transmit switch position. The reflected signal from T/R switch 507 travels to the transmit isolated port of coupler 505. The transmit isolated port of coupler 505 is connected to the receive isolated port of coupler 506 via a connection 511. As such, the connection 511 as shown allows the reflected transmit signal to be passed on to the receive input of receive system 501. The receive system 501 determines/analyzes the characteristics variations of the received signal which is primarily a reflection of the signal transmitted from transmit system 503. The coupled ports of couplers 505 and 506 are connected to ground through a resistor to improve the isolation between the transmit system 503 and receive system 501.

The receive system 501 determines/analyzes the characteristics variations of the received signal which may include phase and/or amplitude variations, and/or frequency of such variations of the received signals. While referring to the internal blocks within receive system 501, the amplitude of the reflected signal may be determined in a number of different ways. For example, a peak detector may be used to detect the variations of the reflected signal amplitude over a period of time. The processing system 502 may performs a Fast Fourier Transform of the signal amplitude variations over a period of time. A distribution of the frequency of the amplitude variations may then be used to determine whether a motion of an object/body and/or gesture has taken place in a proximity of the antenna 508. For example, if the frequency of the amplitude variations is very high or very low, the received signal is not primarily the reflected signal that has been transmitted from the device. If the frequency of the amplitude variations is within certain range of frequencies, the received signal may be considered to be primarily the reflected signal that has been transmitted from the device. One or more representative of the reflected signal is depicted in FIGS. 6, 7 and 8.

While referring to FIGS. 4 and 5, the reflected signal is evaluated for possible characteristics variations which may include phase and/or amplitude variations, and/or frequency of such variations that have been produced by reflection from an object or a human body in a distance from the IoT device. The nature of such characteristics variations which may include phase and/or amplitude variations, and/or frequency of phase and/or amplitude changes are such that they could be associated and correlated with the received signal being produced by such signal reflections. The signal transmitted from the IoT device is not necessarily at a high power level. The transmit signal level should be at a sufficient level, however, to produce a signal reflection from the object or the human body at a level at the receiver for processing. Generally, possible characteristics variations which may include phase and/or amplitude variations, and/or frequency of such phase and/or amplitude variations of the reflected received signal could easily be determined even at a low received signal level.

For the operation of the motion detection and/or gesture recognition, the likelihood of detecting a motion and/or gesture may be improved when the measurements are taken over a number of different channel frequencies. As such, the operations, as described throughout may be repeated over a number of frequency channels. The selected channels may span over the operating frequencies of Bluetooth Network frequency band, as an example. In case of using two antenna system or using a single antenna system, having an object or human body in a proximity of the IoT device causes the resonant frequency of the antenna to change. The changes in the resonant frequency of the IoT device are dynamic and depend on a number of different factors, such as the size, composition, and various movement of the object or the human body. The resonant frequency of the IoT device is also effected by the manufacturing variations, antenna tuning state, etc. Therefore, for the purpose of motion detection and/or gesture recognition, the measurements may be taken over a number of different frequencies. The characteristics of the reflected signals at different transmit frequencies are then evaluated for determining motion detection and/or gesture recognition. The measurement for determining characteristics of the reflected signals is repeated for a number of different frequency channels by for example transmitting the BLE packet 300 over a number of different frequency channels. As explained throughout, the determination of motion detection and/or gesture recognition may be made while the IoT device is in a normal communication with other devices. In one aspect, where Bluetooth normal communication is taking place, the receiver may use the reflected received signals during the transmit portion of the TDD operation. The reflected signal of such communication exchanges (i.e. transmission from the IoT device) in a normal communication may then be used for determining the motion detection and/or gesture recognition. Alternatively or in addition, when the IoT device is in an idle mode (i.e. not in a particular communication with other devices), the device may transmit one or more signals at one or more frequencies over a particular frequency band, and while receiving the reflected transmit signal, the determination for motion detection and/or gesture recognition may be performed.

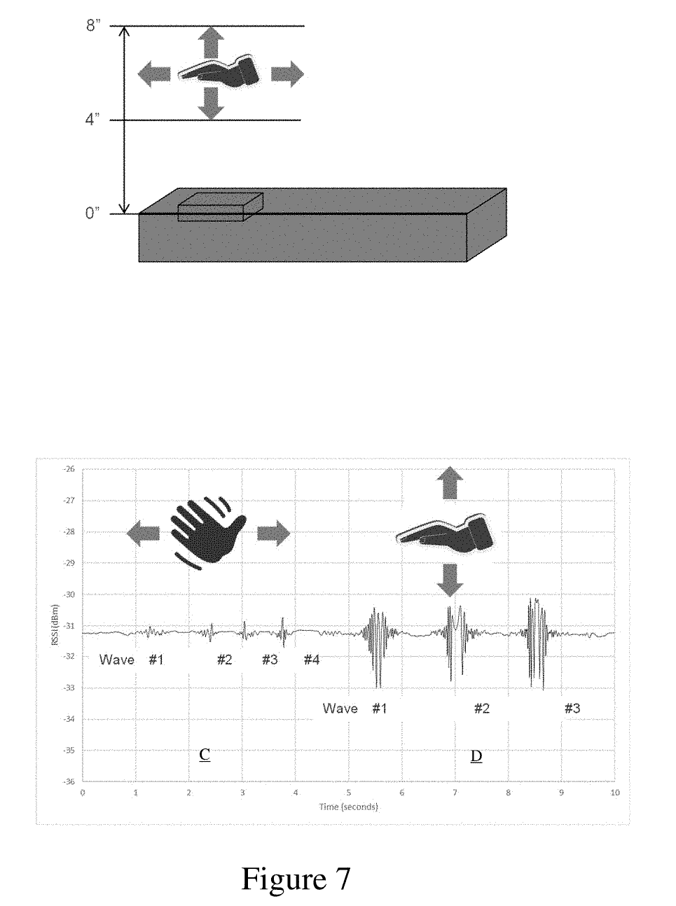

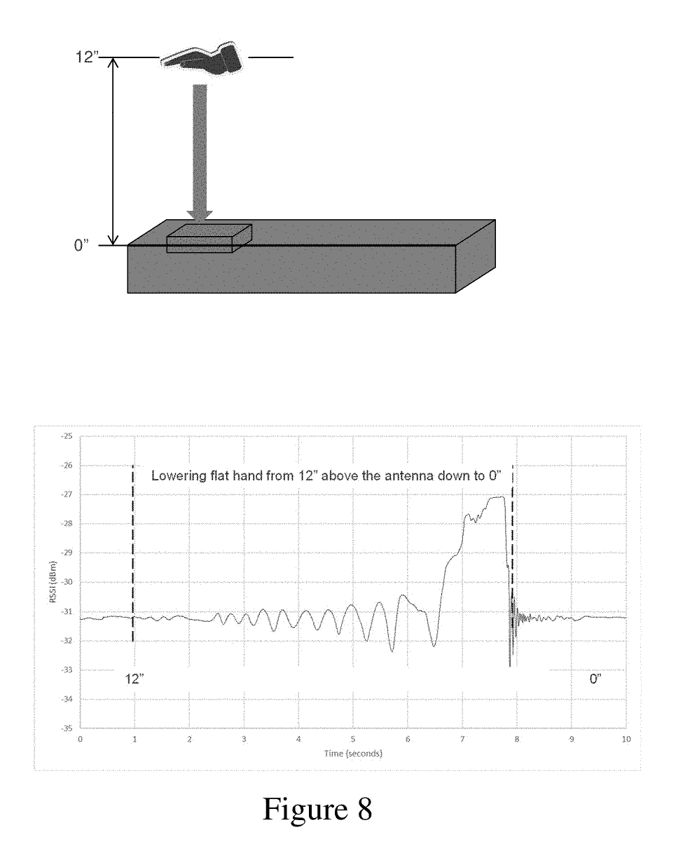

The characteristics of the reflected signal may be defined as changes in possible variations of phase and/or amplitude variations, and/or frequency of phase and/or amplitude variations of the signal. Such changes of the reflected signal are collectively used as an indication of certain motion and/or gesture in a vicinity of the IoT device. Referring to FIG. 6, a signal diagram is shown with various changes in the signal amplitude, as an exemplary reflected signal characteristics. Four different reflected signal characteristics are shown with respect to movement of a human hand near the IoT device at various distances. The signal characteristics A is a representative of motion of a human hand moving in a gesture of up/down in a proximity of between 6-8 inches away from the IoT device. The signal characteristics B, C, and D are also shown as representatives of motion of a human hand moving in a gesture of up/down in various proximity from the IoT device. Referring to FIG. 7, a signal diagram is shown with various changes in the signal amplitude, as another exemplary reflected signal characteristics. Two different reflected signal characteristics are shown with respect to movements of a human hand at a distance of 4-8 inches near the IoT device. The reflected signal characteristics C and D for exemplary movements of a human hand in a horizontal (i.e. waving) and vertical (i.e. up/down) moving gestures are shown. Other types of movement and gestures, such as walking away and walking toward the IoT, fast and slow movements and gestures, far and close distances, produce different characteristics in the reflected signal. Referring to FIG. 8, a signal diagram F is shown, which is a reflected signal characteristics for lowering a hand from a distance to a close proximity of the device antenna. The IoT device may be preprogrammed with an indication of such characteristics such than when the motion detection and/or gesture recognition processes is being performed, the IoT device may correlate the measured characteristics to the stored reflected signal characteristics and make a determination about whether it has detected a motion of an abject/human and/or recognizing a gesture taking place in the vicinity of the IoT device. Moreover, the IoT device may follow a training program to learn about such changes with a user of the IoT device. The result of the training may be stored in the IoT device for a later use, as explained throughout.

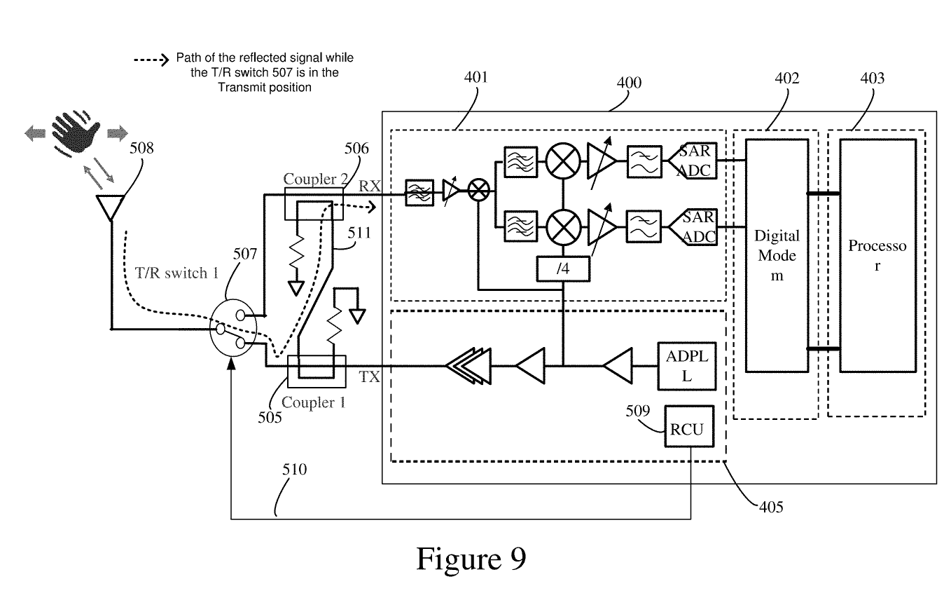

The disclosure relating to the embodiment depicted and explained in relation to FIG. 5 includes use of a combination of one antenna, a T/R switch and two couplers. This combination is connected to the Transmit (TX) and Receive (RX) ports of the system 500. In accordance with various aspects of the disclosure, this combination may also be used with system 400 shown in FIG. 4. The system 400 as shown in FIG. 4 includes certain filtering and signal conversions that allows maintaining a level of isolation between TX and RX ports, as one ordinary skilled in the art may appreciate. System 500 is shown to use the combination of one antenna, a T/R switch and two couplers for at least creating an acceptable isolation between the TX and RX ports for the purpose of motion detection and/or gesture recognition without extensive internal filtering and signal conversions. Referring to FIG. 9, use of system 400 is shown with the combination of one antenna (antenna 508), a T/R switch (T/R switch 507) and two couplers (couplers 505 and 506). Radio controller unit 509 is also shown in FIG. 9 for controlling operation of the T/R switch 507, as explained throughout. The operations and signal flow as described in relation to the combination of one antenna, a T/R switch and two couplers in FIG. 5 are equally applicable when using system 400. Use of the combination of one antenna, a T/R switch and two couplers allows creating an acceptable isolation between the TX and RX ports. For motion detection and/or gesture recognition, in accordance with various aspects of the disclosure, system 400 may reduce its internal operation to what has been depicted in relation to system 500 at different times. For example, when all or most of the functionalities of the internal blocks shown in system 400 are not necessary during motion and/or gesture recognition, system 400 may reduce the functionality of its internal blocks to what has been shown in system 500. As such, a significant reduction for power consumption of the IoT device may be obtained while still performing motion detection and/or gesture recognition. The IoT device may enable the functionalities at a time when they are needed without a need to interrupt or suspend the motion detection and/or gesture recognition processes for an extended period of time.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blue-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. An apparatus for motion detection and/or gesture recognition in a wireless communication device, comprising:
a transmit/receive radio frequency switch including a control input for controlling radio frequency signal routing of the switch from a radio frequency transmit port of the wireless device to an antenna and from the antenna to a radio frequency receive port of the wireless device;
a first radio frequency coupler for coupling to the radio frequency transmit port of the wireless device, and for passing of transmit signals from the radio frequency transmit port to the antenna through the switch;
a second radio frequency coupler for coupling to the radio frequency receive port of the wireless device, and for passing of receive signals from the antenna to the radio frequency receive port through the switch; and
a connector for connecting a transmit isolation port of the first coupler to a receive isolation port of the second coupler.

2. The apparatus of claim 1 further comprising: one or more connectors for connecting a transmit coupled port of the first coupler and a receive coupled port of the second coupler to ground.

3. The apparatus of claim 1 further comprising: a processor coupled with computer readable memory for storing instructions that when executed by the processor cause the processor to perform operations including:
determining whether a source address of a received data packet is a source address of the wireless device;
determining whether a process for the motion detection and/or gesture recognition is enabled in the wireless device; and
processing one or more received signals for the motion detection and gesture recognition occurring in a proximity of the wireless device if the source address of the received data packet is the source address of the wireless device and the process for the motion detection and gesture recognition is enabled in the wireless device, wherein the received data packet is carried by at least one of the one or more received signals that are transmitted from the transmit port of the wireless device and received at the receive port of the wireless device while maintaining signal routing of the switch to route transmit signals from the radio frequency transmit port of the wireless device to the antenna.

4. The apparatus of claim 3 wherein the wherein the operations include: enabling the process for the motion detection and/or gesture recognition based on whether a channel condition experienced by the wireless device exhibiting an amount of signal interference below a signal interference threshold.

5. The apparatus of claim 3 wherein the received data packet is a Bluetooth data packet carrying the source address.

6. The apparatus of claim 3 wherein the processing one or more received signals for the motion detection and/or gesture recognition includes: correlating at least one characteristic pattern of the one or more received signals to one or more different characteristic patterns associated with different motion and/or gesture recognition characteristic patterns.

7. The apparatus of claim 6 wherein the operations include: performing one or more specific task based at least on a result of the correlating at least one characteristic pattern of the one or more received signals to one or more different characteristic patterns.

8. The apparatus of claim 6 wherein the operations include: indicating presence of motion and/or recognizing a gesture of an object or body in the proximity of the wireless device when the correlating at least one characteristic pattern of the one or more received signals to one or more different characteristic patterns satisfies a correlation threshold.

9. The apparatus of claim 3 wherein the one or more received signals are transmitted based on a Time Division Duplex (TDD) transmission scheme.

10. The apparatus of claim 9 wherein a receive operation of the wireless device is in an active receiving state during a transmit timing portion of the TDD transmission scheme.

11. The apparatus of claim 3 wherein the one or more received signals are transmitted from the transmit port of the wireless device and received at the receive port of the wireless device, and wherein the one or more received signals are transmitted in an active communication with another device.

12. The apparatus of claim 3 wherein the one or more received signals are transmitted from the transmit port of the wireless device and received at the receive port of the wireless device.

13. The apparatus of claim 3 wherein the operations further include: determining a channel condition experienced by the wireless device and adjusting a correlation threshold level based on the determined channel condition for correlating at least one characteristic pattern of the one or more received signals to one or more different characteristic patterns.

14. A method for motion detection and/or gesture recognition in a wireless communication device, comprising:
controlling radio frequency signal routing of a transmit/receive radio frequency switch through a control input for routing of radio frequency signals from a radio frequency transmit port of the wireless device to an antenna and from the antenna to a radio frequency receive port of the wireless device;
passing of transmit signals from the radio frequency transmit port to the antenna through the switch via a first radio frequency coupler;
passing of receive signals from the antenna to the radio frequency receive port through the switch via a second radio frequency coupler; and
connecting a transmit isolation port of the first coupler to a receive isolation port of the second coupler via a connector.

15. The method of claim 14 further comprising: connecting a transmit coupled port of the first coupler and a receive coupled port of the second coupler to ground through one or more connectors.

16. The method of claim 14 further comprising: determining whether a source address of a received data packet is a source address of the wireless device;
determining whether a process for the motion detection and/or gesture recognition is enabled in the wireless device; and
processing one or more received signals for the motion detection and gesture recognition occurring in a proximity of the wireless device if the source address of the received data packet is the source address of the wireless device and the process for the motion detection and gesture recognition is enabled in the wireless device, wherein the received data packet is carried by at least one of the one or more received signals that are transmitted from the transmit port of the wireless device and received at the receive port of the wireless device while maintaining signal routing of the switch to route transmit signals from the radio frequency transmit port of the wireless device to the antenna.

17. The method of claim 16 wherein the operation includes: enabling the process for the motion detection and/or gesture recognition based on whether a channel condition experienced by the wireless device exhibiting an amount of signal interference below a signal interference threshold.

18. The method of claim 16 wherein the received data packet is a Bluetooth data packet carrying the source address.

19. The method of claim 16 wherein the processing one or more received signals for the motion detection and/or gesture recognition includes: correlating at least one characteristic pattern of the one or more received signals to one or more different characteristic patterns associated with different motion and/or gesture recognition characteristic patterns.

20. The method of claim 19 wherein the operation includes: performing one or more specific task based at least on a result of the correlating at least one characteristic pattern of the one or more received signals to one or more different characteristic patterns.

21. The method of claim 19 wherein the operation includes: indicating presence of motion and/or recognizing a gesture of an object or body in the proximity of the wireless device when the correlating at least one characteristic pattern of the one or more received signals to one or more different characteristic patterns satisfies a correlation threshold.

22. The method of claim 16 wherein the one or more received signals are transmitted based on a Time Division Duplex (TDD) transmission scheme.

23. The method of claim 22 wherein a receive operation of the wireless device is in an active receiving state during a transmit timing portion of the TDD transmission scheme.

24. The method of claim 16 wherein the one or more received signals are transmitted from the transmit port of the wireless device and received at the receive port of the wireless device, and wherein the one or more received signals are transmitted in an active communication with another device.

25. The method of claim 16 wherein the one or more received signals are transmitted from the transmit port of the wireless device and received at the receive port of the wireless device.

26. The method of claim 16 further comprising: determining a channel condition experienced by the wireless device and adjusting a correlation threshold level based on the determined channel condition for correlating at least one characteristic pattern of the one or more received signals to one or more different characteristic patterns.
